(19) United States
(12) Patent Application Publication
(10) Pub. No.: US 2025/0099889 A1
(43) Pub. Date: Mar. 27, 2025

(54) FILTER HAVING A CIRCUMFERENTIAL SEALING ELEMENT

(71) Applicant: Carl Freudenberg KG, Weinheim (DE)

(72) Inventor: Tobias BEISEL, Wald-Michelbach (DE)

(21) Appl. No.: 18/806,752

(22) Filed: Aug. 16, 2024

(30) Foreign Application Priority Data
Sep. 26, 2023 (EP) 23199850.1

(51) Int. Cl. B01D 46/00; B01D 46/52; B01D 46/62; B60H 3/06; H01M 8/0662

(52) U.S. Cl. CPC B01D 46/0005; B01D 46/0004; B01D 46/0036; B01D 46/521; B01D 46/62; B60H 3/0658; H01M 8/0687; B01D 2271/027; B01D 2279/40; B60H 2003/0691

(57) ABSTRACT

A filter for cleaning an air flow, including at least one first filter element for a first filter stage and a second filter element for a second filter stage. The second filter element is provided with a circumferential sealing element. The sealing element is materially connected to the second filter element. The sealing element includes an outer circumferential sealing surface configured for sealing with respect to a filter receptacle and an inner circumferential sealing surface configured for sealing with respect to the first filter element.

### CROSS REFERENCE TO RELATED APPLICATIONS

This application claims benefit to European Patent Application No. EP 23199850.1, filed on Sep. 26, 2023, which is hereby incorporated by reference herein.

### FIELD

The invention relates to a filter for cleaning an air flow.

### BACKGROUND

Filter elements such as pocket filters, cassette filters, panel filters, edge glue filters or flat filters are known from the prior art. They are used for the filtration of fluids, in particular air. For this purpose, the filter elements are usually inserted into filter housings and locked in place by means of fastening elements, e.g. screwed or latched. To ensure efficient filtration, the connection between the filter and filter frame must have a high degree of tightness. To ensure this, additional seals are usually used. One such filter is described in EP 3 453 441 B1.

US 2016/0 114 275 A1 shows various configurations of filter cartridges that propose a cylindrical filter element and a conical filter element accommodated therein.

DE 10 2013 011 457 A1 describes a filter element for the interior air of a driver's cab of agricultural and work machinery, particularly with sprinkling or spraying devices for pesticides or fertilizers. The interior air filter element comprises an adsorption filter layer with activated carbon, a fine filter layer, particularly for separating aerosols, and a circumferential seal for separating the raw gas side from the clean gas side while being installed in a filter housing.

If the different filter stages consist of different filter elements, each filter element must be securely sealed against the receiving filter housing. When mounting all filter elements, care must also be taken to ensure that the seals of the filter elements are not damaged.

### SUMMARY

In an embodiment, the present disclosure provides a filter for cleaning an air flow, comprising at least one first filter element for a first filter stage and a second filter element for a second filter stage. The second filter element is provided with a circumferential sealing element. The sealing element is materially connected to the second filter element. The sealing element includes an outer circumferential sealing surface configured for sealing with respect to a filter receptacle and an inner circumferential sealing surface configured for sealing with respect to the first filter element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b illustrate an assembly of a filter from two filter elements;

FIG. 2a illustrates an embodiment of a filter;

FIG. 2b illustrates a detailed view of a first filter element;

FIG. 3 illustrates an embodiment of a filter; and

FIG. 4 illustrates a filter assembly with a filter.

### DETAILED DESCRIPTION

In an embodiment, the present invention provides a filter having at least two filter elements for at least two filter stages, which is manufactured using a minimum amount of material and which enables simple and secure mounting in a filter receptacle.

According to the present disclosure, it was recognized as advantageous to provide a sealing element which permits a sealing of the first filter element to the second filter element and a sealing of the second filter element to the filter receptacle.

The filter is used to clean an air flow with at least a first filter element for a first filter stage and a second filter element for a second filter stage. The second filter element is provided with a circumferential sealing element which is materially connected to the second filter element. The material connection of the circumferential seal can be realized, for example, by bonding or by integrated production, so that a secure seal between the filter element and the filter receptacle can be ensured.

According to the present disclosure, the sealing element has at least one external, circumferential sealing surface for sealing against a filter receptacle. The shape of the sealing surface thus corresponds to the shape of the filter receptacle. The filter receptacle can be a filter housing or an air duct. The external, circumferential sealing surface is used for radial sealing of the filter relative to the filter receptacle. Radial thereby means radial to the extent and the flow direction of the filter.

The sealing element has an opening in the middle through which the fluid to be filtered flows during filtration, the opening having an internal, circumferential sealing surface for sealing against the first filter element. The sealing element is therefore shaped in such a way that it surrounds both the first filter element and the second filter element in a frame-like manner. With just one sealing element, the first filter element is thus sealed to the second filter element and the second filter element is sealed to the filter holder.

In an advantageous embodiment of the invention, the first filter element is accommodated in a press seat in the sealing element and the internal sealing surface lies against the first filter element with a press fit.

The inner sealing surface of the sealing element is preferably formed by a sealing lip.

In an undeformed state, i.e. before the first filter element is inserted into the seal, the sealing lip can have an overlap of at least 1 millimeter relative to the mating surface of the first filter element. The sealing element and the first filter element are friction-locked together. For this purpose, the fit between the sealing element and the first filter element is selected in such a way that a press fit is ensured. A press fit can also be referred to as an interference fit. The press fit ensures that the first filter element is held securely in its mounting position, even under mechanical stress during operation.

It has been found that it is advantageous to provide the sealing element with a circumferential compensation groove configured as a circumferential depression arranged on the inflow side. The compensation groove can advantageously reduce restoring forces. In particular, the combination of sealing lip and compensation groove contributes to a leakage-free installation of the filter with very high tightness.

In an embodiment, the sealing element can be injection-molded onto the second filter element, i.e. configured as an injection-molded part made of injection-moldable material, in particular polyurethane or silicone.

It has been found that a Shore hardness A greater than 20 of the sealing element material provides a good seal. In particular, the Shore hardness A can be in the range 20 to 50, with standardized measurements according to DIN ISO 7619-1 or ISO 868 or ASTM D2240.

In an embodiment of the filter, the first filter element and, if applicable, also the second filter element is configured as a bellows made of a pleated filter medium and provided with edge strips all around. If the filter element has a rectangular shape when viewed from above, it is provided with edge strips on its four sides. The first filter element is configured in such a way that it has a certain inherent rigidity so that the circumferential edge strips fit snugly against the inner sealing surface and are not deformed by the sealing surface.

In an embodiment of the filter, the edges of the two end pleats of the filter medium of the first filter element are oriented towards an inflow side of the filter. If an air flow to be cleaned flows through the first filter element, the air flow pushes the respective end pleat of the filter medium and the edge strip radially outwards and a corresponding force is exerted on the sealing element.

In an embodiment of the filter, the first filter element is configured as a particle filter element and/or the second filter element is configured as an adsorption filter element. The adsorption filter element can, for example, have activated carbon as the adsorbent.

The present disclosure also relates to a filter assembly with a filter as described above and a filter housing for accommodating the filter.

In an embodiment of the filter assembly, it has a frame-shaped cap that can be connected to the filter housing or, alternatively, a housing upper part as part of the filter housing, each of which serves to fix the filter in the filter housing. This also prevents the first filter element from slipping out of the sealing element.

The present disclosure also relates to the use of a filter assembly as described above as an interior air filter assembly for filtering and cleaning the cabin inlet air in a vehicle or as an inlet air filter in a fuel cell unit.

In the interior air filter assembly, the cabin air is filtered and cleaned in a vehicle that may be subject to increased pollution, particularly in a commercial vehicle, a heavy-duty vehicle or an off-road vehicle. The vehicles can be, for example, trucks, construction machinery, rollers, tracked vehicles, road milling machines, bulldozers, tracked loaders, excavators, cranes, harvesting machines, agricultural machinery, combine harvesters, chaff cutters, tractors, self-propelled field sprayers, forestry vehicles or similar.

The embodiments of the invention described and the advantageous further embodiments of the invention described represent advantageous further embodiments of the invention also in combination with one another, insofar as this is technically expedient.

Regarding further advantages and constructively and functionally advantageous embodiments of the invention, reference is made to the description of the exemplary embodiments with reference to the accompanying figures.

Embodiments of the invention will be explained in more detail with reference to the attached figures. Corresponding elements and components are provided with the same reference numbers in the figures. For the sake of clarity, the figures have not been drawn to scale.

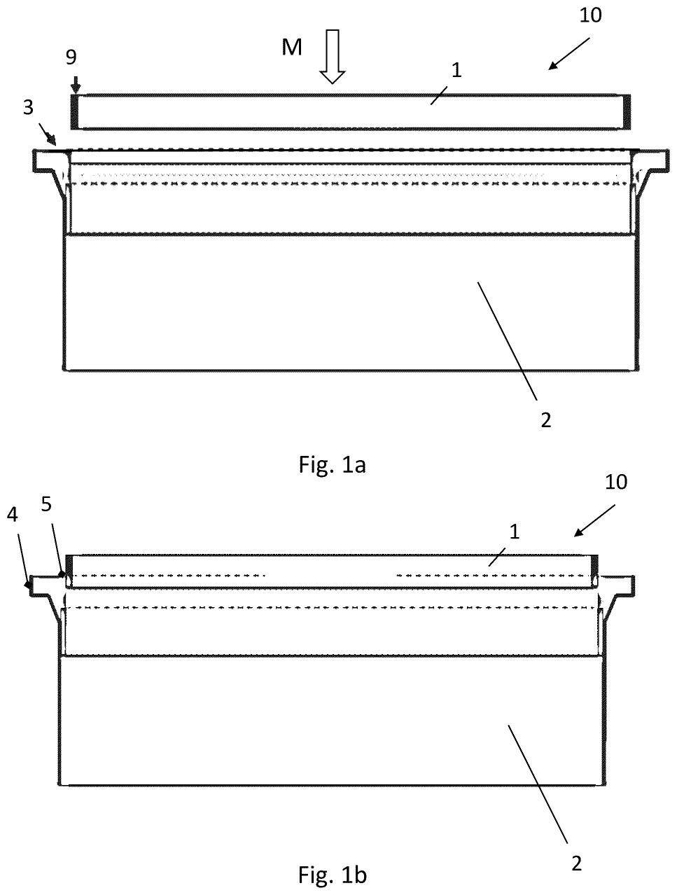

FIGS. 1a and b show the assembly of the filter 10 from two filter elements 1, 2. FIG. 1a shows a first filter element 1, which is inserted in the mounting direction M into a circumferential sealing element 3 located on a second filter element 2. FIG. 1b shows the filter 10 in its fully assembled state. The first filter element 1 and the second filter element 2 are connected to each other via the circumferential sealing element 3. The first filter element 1 is provided with edge strips 9 at its edges. The circumferential sealing element 3 has an internal sealing surface 5. With the outer surfaces of its edge strips 9, the first filter element 1 makes sealing contact with the inner sealing surface 5. To ensure that the first filter element 1 holds securely in the circumferential sealing element 3, the dimensions of the first filter element 1 and the internal sealing surface 5 can be matched to each other in such a way that a press fit is achieved.

The circumferential sealing element 3 is materially connected to the second filter element 2, e.g. bonded. The circumferential sealing element 3 has a further sealing surface, namely an external sealing surface 4. This serves to seal the filter 10 against a filter receptacle 20.

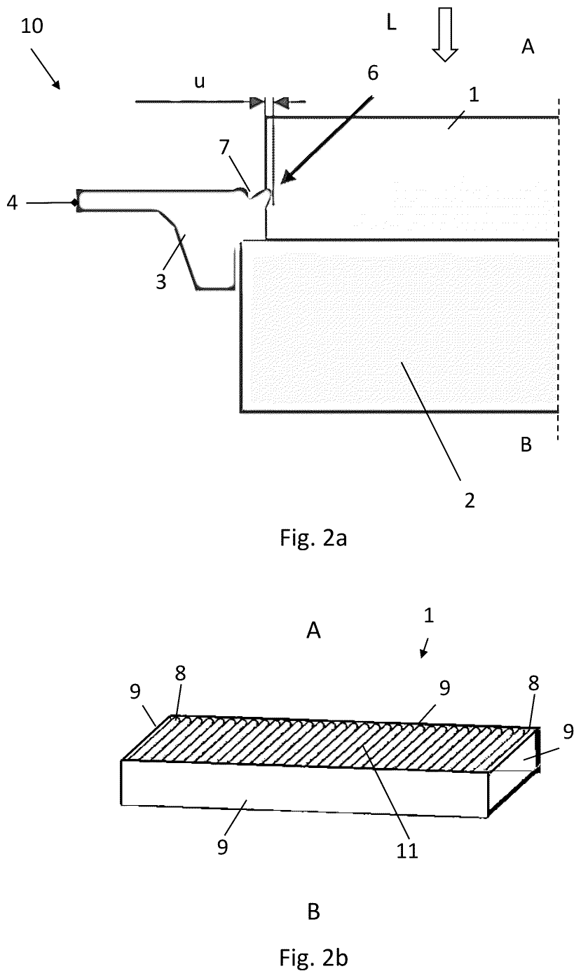

FIG. 2a shows a second embodiment of a filter 10. As in the example described above, the circumferential sealing element 3 and the second filter element 2 are materially connected to each other and the first filter element 1 is accommodated in a press fit in the circumferential sealing element 3. To realize the press fit, the inner sealing surface 5, configured as a sealing lip 6, has an overlap u relative to the mating surface of the first filter element 1. This applies to the undeformed sealing lip 6 before the first filter element 1 is inserted into the circumferential sealing element 3. In the exemplary embodiment shown, the overlap u is greater than 1 mm. For better understanding and for a clear illustration, the sealing lip in FIG. 2a is shown in an undeformed state.

An air flow L flows through the filter 10 from an inflow side A to an outflow side B and the air flow L is cleaned in the process.

The circumferential sealing element 3 has a compensation groove 7, i.e. a depression, on its inflow side.

FIG. 2b shows a detailed view of the first filter element 1 as used in the filters 10 of FIGS. 1a-b and 2a and 4. The first filter element 1 has a bellows 11 made of a pleated filter medium, e.g. non-woven fabric. The end pleats 8 and the side surfaces of the bellows 11 are provided with edge strips 9. The edges of the two end pleats 8 are oriented towards the inflow side A. The second filter element 2 can also have a bellows 11 with edge strips 9 on four sides.

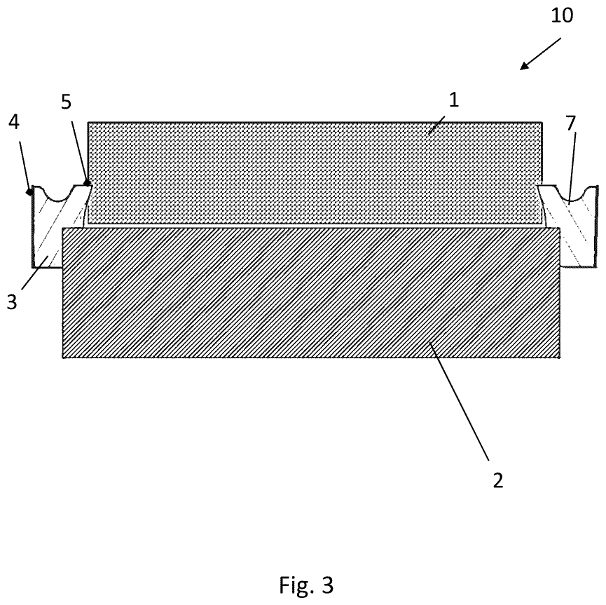

FIG. 3 shows a further embodiment of a filter 10. The first and second filter elements 1 and 2 can also have other configurations and can, for example, be configured as a foamed or honeycombed filter body or as an extruded adsorption element, e.g. as activated carbon honeycombs. A wide variety of shapes can also be provided for the circumferential sealing element 3.

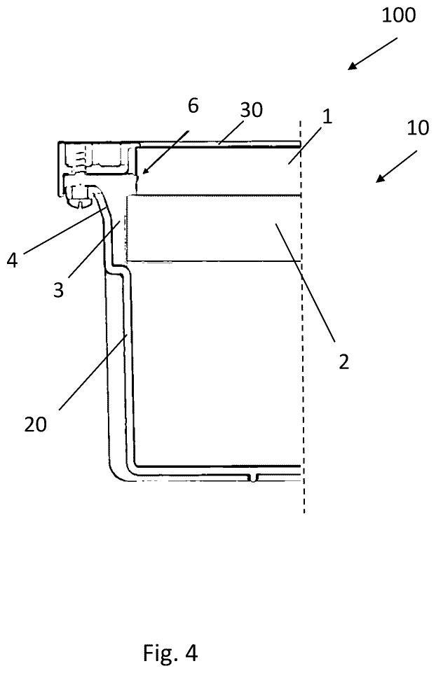

FIG. 4 shows a filter assembly 100 with a filter 10. The filter 10 is accommodated in a filter housing 20 as a filter receptacle. The circumferential sealing element 3 of the filter 10 has at least one of its external sealing surfaces 4 in radial sealing contact with mating surfaces of the filter receptacle 20. The filter 10 is thus essentially leakage-free relative to the filter holder 20.

In order to hold the filter 10 with the first filter element 1 securely in the filter receptacle 20, even in the event of vibrations, a cap 30 is provided, which, after the mounting of the filter 10, is attached to the filter receptacle 20. As indicated in the figure, the cap 30, the circumferential sealing element 3 and the filter receptacle 20 can be screwed together.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 first filter element
2 second filter element
3 circumferential sealing element
4 external sealing surface
5 internal sealing surface
6 sealing lip
7 compensation groove
8 end pleat
9 edge strip
10 filter
11 bellows made of filter medium
20 filter receptacle (e.g. filter housing)
30 cap
100 filter arrangement
A inflow side/raw gas side
B outflow side/clean air side
L air flow
M mounting direction
u overlap

1. A filter for cleaning an air flow, comprising:
at least one first filter element for a first filter stage; and
a second filter element for a second filter stage,
wherein the second filter element is provided with a circumferential sealing element,
wherein the sealing element is materially connected to the second filter element, and
wherein the sealing element includes:
an outer circumferential sealing surface configured for sealing with respect to a filter receptacle, and
an inner circumferential sealing surface configured for sealing with respect to the first filter element.

2. The filter according to claim 1, wherein the first filter element is received in a press fit in the sealing element.

3. The filter according to claim 1, wherein the inner circumferential sealing surface of the sealing element is formed by a sealing lip.

4. The filter according to claim 3, wherein in an undeformed state, the sealing lip has an overlap of at least 1 mm with respect to a mating surface of the first filter element.

5. The filter according to claim 1, wherein the sealing element has a circumferential compensation groove, which is configured as a circumferential depression arranged on an inflow side.

6. The filter according to claim 1, wherein the sealing element is moulded onto the second filter element and is made of polyurethane or silicone.

7. The filter according to claim 1, wherein a material of the sealing element has a Shore A hardness of from 20 to 50.

8. The filter according to claim 1, wherein the first filter element is embodied as a bellows comprising a pleated filter medium and provided circumferentially with edge strips.

9. The filter according to claim 8, wherein edges of two end pleats of the filter medium of the first filter element are oriented towards an inflow side of the filter.

10. The filter according to claim 1, wherein the first filter element is configured as a particle filter element and/or the second filter element is configured as an adsorption filter element.

11. A filter assembly comprising:
the filter according to claim 1; and
a filter housing configured for accommodating the filter.

12. The filter assembly according to claim 11, wherein the assembly has a frame-shaped cap, which is configured to be connected to the filter housing or a housing upper part as part of the filter housing configured for fixing the filter in the filter housing.

13. A vehicle, comprising:
the filter assembly according to claim 11; and
a cabin air inlet,
wherein the filter assembly is configured to filter and clean air passing through the cabin air inlet.

14. A fuel cell unit, comprising:
the filter assembly according to claim 11; and
an inlet air filter,
wherein the filter assembly is configured to filter and clean air passing through the inlet air filter.
